(19) United States
(12) Patent Application Publication
(10) Pub. No.: US 2015/0177742 A1
(43) Pub. Date: Jun. 25, 2015

(54) METHOD FOR CONTROLLING A PUMP STATION

(71) Applicant: XYLEM IP MANAGEMENT S.a.r.l., Senningerberg (LU)

(72) Inventors: Per Ivarsson, Sollentuna (SE); Martin Larsson, Sundbyberg (SE); Leif Sedin, Kista (SE)

(21) Appl. No.: 14/412,229

(22) PCT Filed: Jul. 1, 2013
(86) PCT No.: PCT/SE2013/050839

§ 371 Date: Dec. 31, 2014

(30) Foreign Application Priority Data
Jul. 4, 2012 (SE) 1250761-2

(51) Int. Cl. G05D 9/00

(52) U.S. Cl. CPC G05D 9/00

(57) ABSTRACT

Method for controlling a pump station including a pump well for accommodating liquid and at least one pump located in the pump well for pumping liquid from the pump well, the at least one pump having an inactive state and an active state, respectively. The method includes initiating a pump cycle having a predetermined pump cycle length, bringing the at least one pump to the active state, registering a pump start time of a pumping duration time interval, and calculating a pump stop time for the pumping duration time interval to occur when the quantity of liquid pumped during the pumping duration time interval, as calculated from a predetermined pump capacity of the pump, is greater than or equal to a calculated liquid inflow to the pump well during the present pump cycle. The at least one pump enters said inactive state when the pumping duration time interval has elapsed.

### TECHNICAL FIELD OF THE INVENTION

The present invention relates in general to a method for controlling a pump station comprising a pump well and at least one pump arranged in said pump well, said at least one pump being arranged to take an inactive state and an active state, respectively. The inventive method is directed towards the overall object of minimizing the energy consumption during pumping.

### BACKGROUND OF THE INVENTION AND PRIOR ART

Conventional control of pump stations comprising one or more pumps is usually based on an ON/OFF-control of each pump, wherein a first pump is started at a fixed start level and stopped at a fixed stop level. The stop level of the pump is conventionally located just above the liquid level in the pump well at which the inlet of the pump is located, at the same time the start level of the pump is usually located on the same level as the inlet of the pump station that for instance is located at the upper end of the pump. The start level as well as the stop level is in such conventional pump stations located in the lower part of the pump well, presenting a great safety distance to an overflow level of the pump well. The great safety distance entail that any kind of intelligent or adaptive control of the pump station is unneeded. In the case a momentary inflow substantially exceeds the pump capacity of the active pump a second pump is simply started, and if that is not enough a third pump may be started, etc. However, the inflow is in general considerably less than the inflow for which the pump station and the predetermined start level and stop level are dimensioned.

This conventional way of controlling a pump station solves the basic task to satisfactorily transport the waste water entering the pump station, at the same time as the pump station in an efficient way is prevented from over-flowing. However, this way of controlling a pump station is far from energy efficient. Thereto, the stress on downstream located pipes and downstream located plants, such as sewage treatment plants, is very irregular over time due to the fact that the liquid flow leaving the pump well is in great volumes at large time intervals.

### OBJECT OF THE INVENTION

The present invention aims at obviating the above-mentioned drawbacks and failings of previously known methods for controlling a pump station and at providing an improved method. A basic object of the invention is to provide an improved method of initially defined type, which minimize the energy consumption of the pump station by using the highest possible mean liquid level in the pump well which in its turn minimize the average pumped height of delivery and thereby minimize the energy consumption during pumping.

Another object of the present invention is to provide a method, that pump small volumes at short time intervals, which volumes and time intervals are based on a predetermined number of starts per hour.

It is another object of the present invention to provide a method, which entail that simply one start level has to be set irrespective of the pump station comprises one or several pumps.

It is another object of the present invention to provide a method, which entail that the pump station does not need to comprise dedicated inflow meter and outflow meter respectively.

### BRIEF DESCRIPTION OF THE INVENTION

According to the invention at least the basic object is attain by means of the initially defined method for controlling a pump station, having the features defined in the independent claim. Preferred embodiments of the present invention are further defined in the dependent claims.

According to the present invention it is provided a method of the initially defined type, which is characterized in that it comprises the steps of initiating a pump cycle having a predetermined pump cycle length, bringing said at least one pump, that has at its disposal a start level, to said active state when the present liquid level in the pump well is located at said start level, registering a pump time that run from the point of time when said at least one pump was activated, determining a stop time for said pump time, which stop time occur when the pumped quantity of liquid during said pump time, calculated from a predetermined pump capacity of said at least one pump, is greater than or equal to a calculated liquid inflow to the pump well during the present pump cycle, and bringing said at least one pump to said inactive state when the pump time is equal to the determined stop time.

Thus, the present invention is based on the understanding that by maximizing the mean liquid level in the pump well and by determining the stop time of the pump time in such a way that the pump simply pump out as large liquid volume as calculated inflow during the present pump cycle, a more energy efficient control method is obtained and a more uniform outflow of liquid from the pump station over time.

According to a preferred embodiment of the present invention, the step of determining the calculated liquid inflow to the pump station during the present pump cycle the step of registering an outflow liquid level derivative when the pump is in said active state, and calculating the liquid inflow to the pump during the present pump cycle based on the predetermined pump capacity of said at least one pump and said outflow liquid level derivative.

According to another preferred embodiment of the present invention said at least one pump is controlled by means of ON/OFF-control and has at its disposal a stop condition such that a change of state from said active state to said inactive state is executed, the stop condition comprising said stop time, wherein the step of determining a stop time for said pump time comprises the step of registering present liquid level in the pump well, registering an outflow liquid level derivative when the pump is in said active state, determining an inflow liquid level derivative that is equal to the difference of the predetermined pump capacity of the pump minus said outflow liquid level derivative, and determining said stop time, which occur when the sum of the pump time and the product of said start level minus present liquid level divided by the inflow liquid level derivative, is equal to said predetermined pump cycle length.

In yet another preferred embodiment the inventive method also comprises the steps of comparing the inflow liquid level derivative and a predetermined value at a predetermined present liquid level, and determining a value of the start level that is less than a standard value of the start level if the inflow liquid level derivative exceed the predetermined value at the predetermined present liquid level. In this way a safety marginal is obtained at great momentary inflow of liquid to the pump station.

Preferably the method also comprises the steps of calculating the product of said start level minus present liquid level divided by the inflow liquid level derivative, comparing said calculated product with a predetermined shortest pause time, and retaining the pump in said active state the entire present pump cycle if the calculated product is greater than said predetermined shortest pause time. In this way the energy consumption is minimized by remaining the pump active, in the case the theoretical energy saving when the pump could be kept inactive is less than the relatively large initial energy consumption in connection with deactivation and activation of the pump.

Further advantages with and features of the invention will be apparent by the other dependent claims as well as by the following, detailed description of preferred embodiments.

### BRIEF DESCRIPTION OF THE DRAWINGS

A more complete understanding of abovementioned and other features and advantages of the present invention will be apparent from the following, detailed description of preferred embodiments with reference to the enclosed drawings, in which:

FIG. 1 is a schematic illustration of a pump station.

### DETAILED DESCRIPTION OF PREFERRED EMBODIMENTS

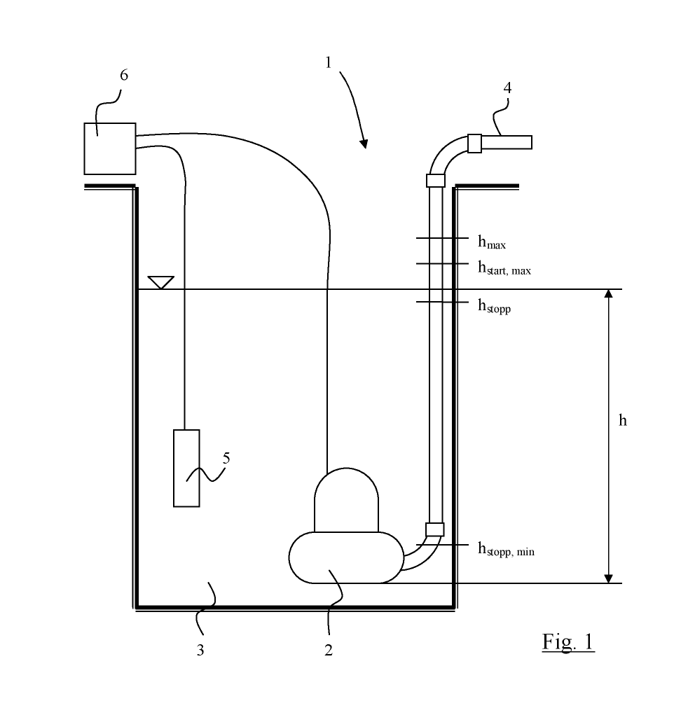

In FIG. 1 is shown a pump station, generally designated 1, comprising at least one pump 2, which is arranged to take an inactive state and an active state, respectively. The pump 2, when it is in said active state, is arranged to pump liquid from a pump well 3 comprised in the pump station 1 to an outlet pipe 4 and further away from the pump station 1. Thereto, the pump station 1 comprises some kind of customary level sensor arrangement, that comprises at least one level sensor 5 arranged to determine the present liquid level h in the pump well 3. It shall be pointed out that the level sensor 5 can be a separate device that is operatively connected to an external control unit 6, that is operatively connected to said at least one pump 2, that is built-in in said at least one pump 2, etc. The level sensor 5 is preferably of the type dynamic level sensors, also known as continuous, analogous, etc. Dynamic level sensors, such as submersed acoustic level sensors or above hanging sound echo or light reflection level sensors, can unlike static level sensors continuously register the present liquid level in the pump well 3. By means of such level sensors 5 also the liquid level derivative, i.e. the speed of change of the present liquid level, can be determined.

The present invention relates to a method for controlling such a pump station 1, in order to minimize the energy consumption of said pump station 1. The pump station 1 shall in this context be regarded as a delimited installation in which incoming liquid arrive and from which outgoing liquid is pumped. The pump station 1 shall, for the matter of the present invention, be regarded independently of the type of liquid and independently of from where the liquid comes and whereto the liquid is pumped. The inventive method may for instance be implemented in a built-in control unit in the pump 2 or in the external control unit 6 in a control cabinet, the external control unit 6 being operatively connected to the pump 2.

It shall be pointed out that the inventive method may be expanded with one or more sub methods, and/or be run in parallel/sequence with other control methods.

The inventive method comprises the steps of initiating a pump cycle having a predetermined pump cycle length, bringing said at least one pump 2 to said active state, registering a pump time running from the point of time when said at least one pump 2 was activated, and determining a stop time for said pump time, which stop time occur when the pumped liquid volume during the present pump time, calculated from the predetermined pump capacity of said at least one pump 2, is greater than or equal to a calculated liquid inflow to the pump well 3 during the present pump cycle. Thus, the pump time will be minimized by having the pump active during the separate pump cycle just as long as the calculated inflow during the present pump cycle is pumped out.

The pump cycle length of a pump cycle is for instance more than 4 minutes and less than 10 minutes and according to the abovementioned method the pump 2 is arranged to start/active one time per pump cycle, which give less than or equal to 15 activations per hour and more than or equal to 6 activations per hour, respectively. However, it shall be pointed out that the pump cycle length of a pump cycle may be longer than 10 minutes, for instance up to one or several hours.

In practice it is preferred that the pump 2 is activated jointly as a pump cycle is initiated, and/or that the pump cycle is initiated by the activation of the pump 2. Preferably, said pump 2 is controlled by means of ON/OFF-control and has at its disposal a start level hₛₜₐᵣₜ, that in the disclosed embodiment is constituted by the maximum start level h_{start,max}, at which the change of state from the inactive state to the active state shall be executed. A fundamental intention of the present invention is that the pump station 1 solely shall be in possession of one predetermined start level irrespective of the number of pumps arranged in the pump station 1. In the cases the pump station comprises several pumps the mutual alternation shall be executed in a suitable way, in order to obtain uniform load between the pumps.

The method step of bringing said at least one pump 2 to said active state comprises preferably the steps of registering the present liquid level h in the pump well 3, and bringing said at least one pump 2 to said active state when the present liquid level h in the pump well 3 is located at said start level hₛₜₐᵣₜ. By the expression “at its disposal”, as used in the claims as well as in the detailed description, it is intended that the start level for instance is found in said external control unit 6 and that it generates the change of stat of the pump 2, alternatively the start level hₛₜₐᵣₜ may be found in a control unit in the pump 2, or the like.

The present liquid level h in the pump well 3 is in the present patent application the distance between the liquid level in the pump well 3 and the inlet of the pump 2 (see FIG. 1), the liquid level h is also connected to the actual height of delivery of the pump 2, which height of delivery increase with decreasing liquid level h. When the pump well 3 is filled with liquid the liquid level h increase and when the pump 2 is active and pump out liquid the liquid level h decrease. It shall be pointed out that the pump well 3 can be filled with liquid at the same time as the pump 2 is active and pump out liquid.

Preferably the maximum start level h_{start,max} of the pump 2 correspond to a liquid level in the pump well 3 that by a margin is located at a distance from the liquid level in the pump well 3 when the pump station 1 overflow, and preferably also at a distance from the maximum liquid level hₘₐₓ in the pump well 3 when the pump station 1 enter a high alarm state, that for instance may imply that another or several pumps are started and/or that service staff is called to the pump station 1.

In connection with that the pump 2 is activated, as described above, a pump time is started that run until the abovementioned stop time for the pump occur and the pump 2 thereby return to the inactive state. Thus, the pump 2 has at its disposal a stop condition for the execution of the change of state from said active state to said inactive state, which stop condition comprises said stop time. Dependent on varying inflow of liquid to the pump station 1 the stop time will vary and thereby the actual stop level. Preferably, the step of determining said stop time comprises the steps of registering the present liquid level h in the pump well 3, registering an outflow liquid level derivative when the pump 2 is in said active state, determining an inflow liquid level derivative that is equal to the difference of the predetermined pump capacity of the pump 2 minus said outflow liquid level derivative, and determining said stop time, which occur when the sum of the pump time and the product of said start level hₛₜₐᵣₜ minus present liquid level 4 divided with the inflow liquid level derivative, is equal to said predetermined pump cycle length.

By the expression “at its disposal”, as used in the claims as well as in the detailed description, it is intended that the stop condition for instance is handled in said external control unit 6 and that it generates the change of stat of the pump 2, alternatively the stop condition may be handled directly in a control unit in the pump 2, or the like.

The outflow liquid level derivative when the pump 2 is in the active state indicate at which speed the present liquid level h in the pump well 3 is changed when the pump 2 is active, and is registered by means of the level sensor 5 as described above.

The inflow liquid level derivative is in its turn a measure of the liquid inflow to the pump well 3 during the present pump cycle, and indicate at which speed the present liquid level h in the pump well 3 should alter if the pump 2 would have been inactive.

The determination of the calculated liquid inflow to the pump well 3 during the present pump cycle comprises preferably the steps of registering the outflow liquid level derivative when the pump 2 is in said active state, and thereafter calculate the liquid inflow to the pump well 3 during the present pump cycle based on the predetermined pump capacity of said at least one pump 2 and said outflow liquid level derivative.

The pump capacity is preferably determined by means of pump capacity liquid level derivative that indicate at which speed the present liquid level h in the pump well 3 should alter if the pump 2 is active and the inflow is equal to zero.

In connection with momentary large liquid inflows to the pump well 3, irrespective of the pump 2 is active or inactive, there may be need for additional safety margin to said maximum liquid level hₘₐₓ in the pump well 3. This become apparent, when the pump 2 is inactive during the present pump cycle, that the speed at which the present liquid level h increase is greater than normal and, when the pump 2 is active during the present pump cycle, that the speed at which the present liquid level h decrease is less than normal or negative. In order to determine this temporary safety margin the inventive method preferably comprises also the step of comparing the inflow liquid level derivative with a predetermined value at a predetermined present liquid level h, and determining a value of the start level hₛₜₐᵣₜ that is lower than the standard value of the start level, which preferably is the maximum start level h_{start,max}, if the inflow liquid level derivative exceed the predetermined value at the predetermined present liquid level h. In an alternative embodiment several pumps may be activated in connection with the start of the next pump cycle, when the present liquid level h reach the standard value of the start level, in response to the inflow liquid level derivative exceeding the predetermined value at the predetermined present liquid level h. In yet another alternative embodiment the abovementioned two alternatives may be combined such that several pumps are activated at a present liquid level h that is lower than the standard value of the start level.

In connection with the pump 2 being active and the stop time is about to be determined it is also preferred to examine how long time the pump will be inactive, e.g. how long pause time the pump 2 will have before the next pump cycle is initiated. At a too short pause time the energy saving during the pause time will be lower than the extra momentary energy consumption that is associated with the activation of the pump 2 in the next pump cycle. Thus, it is then more advantageous to let the pump 2 stay active the entire present pump cycle and thereafter start a new pump cycle. Preferably the examination of the length of the pause time is executed by means of the steps of calculating the product of the present start level hₛₜₐᵣₜ , for instance maximum start level h_{star,max}, minus the present liquid level h divided with the inflow liquid level derivative, comparing said calculated product with a predetermined minimum pause time, and remaining the pump 2 in said active state the entire present pump cycle if the determined product is greater than said predetermined minimum pause time.

Furthermore it is preferred, in connection with the pump 2 being active and the stop time is about to be determined, to examine that the pump 2 is not active to short time during relatively small momentary inflows. By other words, the pump 2 shall not be active such short time that it does not manage to pump out any significant quantity of liquid at the same time as the pump 2, during the short time it has been active, had a relatively high energy consumption. Thus, it is preferred that the pump time is greater than or equal to a predetermined minimum pump time, that is set value. The minimum pump time is preferably longer than 30 seconds and preferably less than 120 seconds.

Alternatively the predetermined minimum pump time may be a calculated value. Said calculated value of the minimum pump time is preferably obtained by means of a sub method, designated Optimum pump time. Said sub method, Optimum pump time, comprises the steps of bringing said at least one pump 2 to said active state when the present liquid level h in the pump well 3 is located at said start level hₛₜₐᵣₜ, registering the energy consumption as a function of elapsed pump time when the pump 2 is in said active state, registering the pumped quantity of liquid from the pump well 3 as a function of elapsed pump time when the pump 2 is in said active state, and determining the minimum specific energy consumption E_{spec,min} as a function of elapsed pump time by means of the product of the energy consumption divided with the pumped quantity of liquid. Thus, the optimum pump time is the time when the minimum energy consumption occurs. The pumped quantity of liquid is preferably obtained as the predetermined pump capacity of the pump multiplied by the elapsed pump time.

In connection with the pump station, or new pumps, etc., is put into operation a sub method, designated Initiation, is preferably executed. Said sub method, Initiation, is used to determine the pump capacity for each pump 2 in the pump station 1, alternatively also for combinations of pumps 2.

The sub method comprises the steps of registering an inflow liquid level derivative when said at least one pump 2 is in the inactive state, bringing said at least one pump 2 to said active state when the present liquid level h in the pump well 3 is located at said start level hₛₜₐᵣₜ, registering an outflow liquid level derivative when the pump 2 is in said active state, and determining the pump capacity of said at least one pump 2 as the sum of the inflow liquid level derivative and the outflow liquid level derivative.

It shall be pointed out that the mutual order between the registering of the inflow liquid level derivative and the outflow liquid level derivative, respectively, is arbitrary.

When the pump 2 has been activated it is preferred that a stable outflow is awaited before the outflow liquid level derivative is registered, due to stagnant liquid downstream the pump station 1 shall be put into motion and this affects the outflow liquid level derivative in a negative way. Stable outflow may be awaited by examining how the outflow liquid level derivative varies or by waiting a predetermined time.

As a concluding sub method step said at least one pump 2 shall preferably be brought to said inactive state at a predetermined stop level, said predetermined stop level being equal to a predetermined minimum stop level h_{stopp,min}, or a snoring level for said pump 2.

One result of the inventive method is that less volume of liquid is pumped during each activation, at the same time as the pump well 3 rarely or never is emptied. In order to handle the problems that may arise due to the above, a pump well cleaning and/or pipe cleaning ought to be performed at even intervals. In connection with pump well cleaning and/or pipe cleaning one or several pumps are activated and they remain activated until snoring occurs, i.e. pumps a mixture of air and liquid. Preferably this is performed at a point of time having low tariff cost.

### FEASIBLE MODIFICATIONS OF THE INVENTION

The invention is not limited only to the embodiments described above and shown in the drawings, which primarily have an illustrative and exemplifying purpose. This patent application is intended to cover all adjustments and variants of the preferred embodiments described herein, thus the present invention is defined by the wording of the appended claims and the equivalents thereof. Thus, the equipment may be modified in all kinds of ways within the scope of the appended claims.

It shall be pointed out that even thus it is not explicitly stated that features from a specific embodiment may be combined with features from another embodiment, the combination shall be considered obvious, if the combination is possible.

1. A method for controlling a pump station comprising at least one pump located in a pump well for accommodating liquid, said at least one pump configured to pump said liquid from the pump well, said at least one pump having an inactive state and an active state, and having at its disposal a predetermined pump start level (hₛₜₐᵣₜ) corresponding to a predetermined liquid level (h) in the pump well, the method comprising the steps of:
(a) initiating a pump cycle having a predetermined pump cycle length,
(b) bringing said at least one pump to said active state in response to the pump well liquid level (h) reaching said predetermined pump start level (hₛₜₐᵣₜ),
(c) registering a pump start time for a pumping duration time interval, said pump start time occurring when said at least one pump was activated,
(d) determining a pump stop time for said pumping duration time interval, including calculating a pump stop time corresponding to a time when a pumped quantity of liquid during said pumping duration time interval, as calculated from a predetermined pump capacity of said at least one pump, is greater than or equal to a calculated liquid inflow to the pump well during the pump cycle initiated in step (a), and
(e) bringing said at least one pump to said inactive state when the pumping duration time interval has elapsed.

2. The method according to claim 1, wherein said at least one pump is controlled by ON/OFF-control and the step (b) of bringing said at least one pump to said active state comprises the steps of:
registering the present liquid level (h) in the pump well, and
bringing said at least one pump (2) to said active state using said ON/OFF control when the present liquid level (h) in the pump well is located at said start level (hₛₜₐᵣₜ).

3. The method according to claim 1, wherein determining the calculated liquid inflow to the pump well during the present pump cycle in step (d) comprises the steps of:
(d)(i) registering an outflow liquid level derivative when the pump is in said active state, and
(d)(ii) calculating the liquid inflow to the pump well during the present pump cycle based on the predetermined pump capacity of said at least one pump and said outflow liquid level derivative.

4. The method according to claim 1, wherein said at least one pump is controlled by ON/OFF-control and has at its disposal a stop condition at which a change of state from said active state to said inactive state shall be executed, the stop condition comprising said pump stop time, wherein the step of determining the pump stop time for said pumping duration time interval in step (d) comprises the steps of:
(d)(i) registering the present liquid level (h) in the pump well,
(d)(ii) registering an outflow liquid level derivative when the pump is in said active state,
(d)(iii) determining an inflow liquid level derivative that is equal to the predetermined pump capacity of the pump minus said outflow liquid level derivative, and
(d)(iv) determining said stop time, which occurs when the sum of the pumping duration time interval and the product of said pump start level (hₛₜₐᵣₜ) minus the present liquid level (h) divided by the inflow liquid level derivative, is equal to said predetermined pump cycle length.

5. The method according to claim 4, also comprising the steps of:
comparing the inflow liquid level derivative with a predetermined liquid level derivative value at a predetermined liquid level, and
determining a value for the pump start level (hₛₜₐᵣₜ) that is lower than a standard value of the pump start level if the inflow liquid level derivative exceeds the predetermined liquid level derivative value at the predetermined liquid level.

6. The method according to claim 5, wherein the standard value of the pump start level is equal to a predetermined maximum start level (h_{start,max}).

7. The method according to claim 4, also comprising the steps of:
(d)(v) calculating a value equal to said pump start level (hₛₜₐᵣₜ) minus the present liquid level (h) divided by the inflow liquid level derivative,
(d)(vi) comparing said value calculated in step (d)(v) with a predetermined minimum pause time, and
(d)(vii) retaining the pump in said active state for an entirety of the present pump cycle if the value calculated in step (d)(v) is greater than said predetermined minimum pause time.

8. The method according to claim 1, wherein the step of calculating the predetermined pump capacity in step (d) comprises a sub-method comprising the steps of:
registering an inflow liquid level derivative when said at least one pump is in the inactive state,
bringing said at least one pump to said active state when the present liquid level (h) in the pump well is located at said start level (hₛₜₐᵣₜ),
registering an outflow liquid level derivative when the pump is in said active state, and
determining the pump capacity of said at least one pump as a sum of the inflow liquid level derivative and the outflow liquid level derivative.

9. The method according to claim 8, wherein the sub-method, also comprises the step of:
awaiting stable outflow before the outflow liquid level derivative is registered.

10. The method according to claim 8, wherein the sub method also comprises the steps of:
bringing said at least one pump to said inactive state before the pumping duration time interval has elapsed if the liquid reaches a predetermined stop level, said predetermined stop level being equal to a predetermined minimum stop level (h_{stopp,min}), or a snoring level of said pump.

11. The method according to claim 1, further comprising setting said pumping duration time interval to be greater than or equal to a predetermined set minimum pumping duration time interval.

12. The method according to claim 1, further comprising setting said pumping duration time interval to be greater than or equal to a calculated minimum pumping duration time interval.

13. The method according to claim 12, wherein said calculated minimum pumping time interval is obtained by a sub method comprising the steps of:
bringing said at least one pump to said active state when the present liquid level in the pump well is located at said start level (hₛₜₐᵣₜ);
registering an energy consumption of the pump as a function of elapsed pump time when the pump is in said active state,
registering the pumped quantity of liquid from the pump well as a function of elapsed pump time when the pump is in said active state, and
determining a minimum specific energy consumption (E_{spec,min}) as a function of elapsed pump time by calculating the energy consumption divided by the pumped quantity of liquid.
